(19) United States
(12) Patent Application Publication
(10) Pub. No.: US 2025/0291080 A1
(43) Pub. Date: Sep. 18, 2025

(54) VELOCITY IDENTIFICATION METHOD AND APPARATUS FOR INTERBED MULTIPLES

(71) Applicant: CHINA NATIONAL PETROLEUM CORPORATION, Beijing (CN)

(72) Inventors: Junfa XIE, Beijing (CN); Xingrong XU, Beijing (CN); Zhe YANG, Beijing (CN); Linghe HAN, Beijing (CN); Yundong YONG, Beijing (CN); Yuhe ZHAO, Beijing (CN); Yihui WANG, Beijing (CN); Shengtao ZANG, Beijing (CN)

(73) Assignee: CHINA NATIONAL PETROLEUM CORPORATION, Beijing (CN)

(21) Appl. No.: 18/861,922

(22) PCT Filed: Dec. 25, 2023
(86) PCT No.: PCT/CN2023/141466

§ 371 Date: Nov. 15, 2024

(30) Foreign Application Priority Data
Apr. 24, 2023 (CN) 202310449764.8

(51) Int. Cl. G01V 1/30; G01V 1/34; G01V 1/36

(52) U.S. Cl. CPC G01V 1/305; G01V 1/34; G01V 1/36

(57) ABSTRACT

This disclosure discloses a velocity identification method and apparatus for interbed multiples, including: obtaining a velocity spectrum and propagation paths of interbed multiples in a stratum; collecting, from the velocity spectrum, velocities of a plurality of energy clusters, and obtaining propagation velocities and propagation duration of a plurality of primaries; calculating propagation velocities and propagation duration of an interbed multiples corresponding to each primary order by order, to obtain propagation velocities and propagation duration of low-order interbed multiples; and determining a horizon at which a low-order interbed multiples are generated and an order of the low-order interbed multiples; and identifying the interbed multiples based on the propagation velocities and the propagation duration of the low-order interbed multiples, the horizon at which the low-order interbed multiples are generated, and the order of the low-order interbed multiples, and in combination with the velocity spectrum.

### RELATED APPLICATIONS

This disclosure claims priority to Chinese Patent Application No. 202310449764.8, filed on Apr. 24, 2023, which is hereby incorporated herein by reference in its entirety.

### TECHNICAL FIELD

This disclosure relates to the field of exploration geophysics, and particular to a velocity identification method and apparatus for interbed multiples.

### BACKGROUND

This part is intended to provide a background or context for embodiments of this disclosure as stated in the claims. The description herein is not regarded as prior art just because the description is included in this part.

In conventional seismic data processing, multiples are regarded as a kind of coherent noise that seriously interferes with primaries, which not only reduces a signal-to-noise ratio of seismic data, but also seriously affects authenticity and reliability of seismic imaging, thereby adversely affecting the subsequent interpretation work. The multiples may be classified into interbed multiples and surface-related multiples, and the surface-related multiples have a great velocity difference from the primaries, which are more easily identified and suppressed.

The interbed multiples are generated by multiple wave reflections of seismic waves between underground interfaces, and dynamic and kinematic characteristics of the interbed multiples are highly similar to those of the primaries, which are difficult to identify and suppress. As an order of the interbed multiples is greater, a difference between the interbed multiples and the primaries is greater, and the interbed multiples are more easily identified and suppressed. Therefore, as the order of the interbed multiples is lower, dynamic and kinematic characteristics of the interbed multiples are more similar to dynamic and kinematic characteristics of the primaries. Especially when a distance between two reflection interfaces that generate the interbed multiples is small, it is extremely difficult to identify the low-order interbed multiples. There is no solution to this problem in the prior art.

### SUMMARY

Embodiments of this disclosure provide a velocity identification method for interbed multiples, to effectively identify the interbed multiples and provide a basis and means for suppression of the interbed multiples. The method includes:

obtaining a velocity spectrum and propagation paths of interbed multiples in a stratum;

collecting, from the velocity spectrum, velocities of a plurality of energy clusters whose energy exceeds a preset value, and obtaining propagation velocities of a plurality of primaries and propagation duration of the plurality of primaries;

calculating, based on the propagation duration of the plurality of primaries and propagation velocities of the plurality of primaries, and in combination with the propagation paths of the interbed multiples in the stratum, propagation velocities and propagation duration of interbed multiples corresponding to each primary order by order, to obtain propagation velocities and propagation duration of low-order interbed multiples;

determining a horizon at which the low-order interbed multiples are generated and an order of the low-order interbed multiples; and

identifying the interbed multiples based on the propagation velocities and the propagation duration of the low-order interbed multiples, the horizon at which the low-order interbed multiples are generated, and the order of the low-order interbed multiples, and in combination with the velocity spectrum.

An embodiment of this disclosure further provides a velocity identification apparatus for an interbed multiples, to effectively identify the interbed multiples, providing a basis and means for suppression of the interbed multiples. The apparatus includes:

a first obtainment module, configured to obtain a velocity spectrum and propagation paths of interbed multiples in a stratum;

a second obtainment module, configured to collect, from the velocity spectrum, velocities of a plurality of energy clusters whose energy exceeds a preset value, and obtain propagation velocities of a plurality of primaries and propagation duration of the plurality of primaries;

a calculation module, configured to calculate, based on the propagation duration of the plurality of primaries and propagation velocities of the plurality of primaries, and in combination with the propagation paths of the interbed multiples in the stratum, propagation velocities and propagation duration of an interbed multiples corresponding to each primary order by order, and obtain propagation velocities and propagation duration of low-order interbed multiples; and determine a horizon at which low-order interbed multiples are generated and an order of the low-order interbed multiples; and

an identification module, configured to identify the interbed multiples based on the propagation velocities and the propagation duration of the low-order interbed multiples, the horizon at which the low-order interbed multiples are generated, and the order of the low-order interbed multiples, and in combination with the velocity spectrum.

An embodiment of this further provides a computer device, including a memory, a processor, and a computer program stored in the memory and executable on the processor. When executing the computer program, the processor implements the velocity identification method for an interbed multiples.

An embodiment of this disclosure further provides a computer-readable storage medium. The computer-readable storage medium stores a computer program. When executed by a processor, the computer program implements the velocity identification method for an interbed multiples.

An embodiment of this disclosure further provides a computer program product. The computer program product includes a computer program. When executed by a processor, the computer program implements the velocity identification method for an interbed multiples.

In the embodiments of this disclosure, the velocity spectrum and the propagation path of the interbed multiples in the stratum are obtained; the velocities of the plurality of energy clusters whose energy exceeds a preset value are collected from the velocity spectrum, and the propagation velocities of the plurality of primaries and the propagation duration of the plurality of primaries are obtained; the propagation velocities and the propagation duration of the interbed multiples corresponding to each primary are calculated order by order, based on the propagation duration of the plurality of primaries and propagation velocities of the plurality of primaries, and in combination with the propagation paths of the interbed multiples in the stratum, to obtain the propagation velocities and the propagation duration of the low-order interbed multiples; the horizon at which the low-order interbed multiples are generated and the order of the low-order interbed multiples are determined; and the interbed multiples are identified based on the propagation velocities and the propagation duration of the low-order interbed multiples, the horizon at which the low-order interbed multiples are generated, and the order of the low-order interbed multiples, and in combination with the velocity spectrum. In this way, based on the propagation velocities of the primaries and propagation duration of the primaries, the propagation velocities and propagation duration of the low-order interbed multiples are calculated, and then in combination with the velocity spectrum the interbed multiples are identified, so that the velocity spectrum of the interbed multiples can be identified, the horizon at which the interbed multiples are generated, and the order of the interbed multiples can be obtained, thereby providing effective information for suppression of the interbed multiples.

### BRIEF DESCRIPTION OF THE DRAWINGS

To describe the technical solutions in embodiments of this disclosure or in the prior art more clearly, the following briefly describes the drawings for describing embodiments or the prior art. It is clear that the drawings in the following descriptions show merely some embodiments of this disclosure, and a person of ordinary skill in the art may still derive other drawings from these drawings without inventive efforts. In the drawings,

FIG. 1 is a schematic flowchart of a velocity identification method for interbed multiples according to an embodiment of this disclosure;

FIG. 2 is a schematic diagram of a velocity model according to an embodiment of this disclosure;

FIG. 3 is a schematic diagram of gathers according to an embodiment of this disclosure;

FIG. 4 is a schematic diagram of a velocity spectrum according to an embodiment of this disclosure;

FIG. 5 is a schematic diagram of velocity identification of interbed multiples according to an embodiment of this disclosure;

FIG. 6 is a schematic diagram of actual CMP gathers and a velocity spectrum thereof according to an embodiment of this disclosure;

FIG. 7 is a schematic diagram of an identification result of actual CMP gathers and a velocity spectrum thereof according to an embodiment of this disclosure;

FIG. 8 is a schematic diagram of a velocity identification apparatus for interbed multiples according to an embodiment of this disclosure; and

FIG. 9 is a structural block diagram of an electronic device according to an embodiment of this disclosure.

### DESCRIPTION OF THE EMBODIMENTS

To make the objectives, technical solutions, and advantages of embodiments of this disclosure clearer, the embodiments of this disclosure will be further described in detail below with reference to the drawings. The embodiments of this disclosure and descriptions thereof are used to explain this disclosure, but are not used as a limitation on this disclosure.

The term “and/or” in this specification describes only an association relationship and indicates that three relationships may exist. For example, A and/or B may indicate the following three cases: Only A exists, both A and B exist, and only B exists. In addition, the term “at least one” in this specification means any one of a plurality or any combination of at least two of a plurality, for example, including at least one selected from A, B, and C, which can mean including any one or more elements selected from a set composed of A, B and C.

In the description of this specification, the “include”, “comprise”, “has”, “contain”, and the like used are all open terms, which mean including but not limited to. Description with reference to the term “one embodiment,” “a specific embodiment,” “some embodiments,” “such as,” or the like in the means that a specific feature, structure, or characteristic described in connection with the embodiment or example is included in at least one embodiment or example of this disclosure. In this specification, illustrative expressions of the terms do not necessarily mean a same embodiment or a same example. Moreover, the specific feature, structure, or characteristic described may be combined in any suitable manner in any one or more embodiments or examples.

A sequence of steps in each embodiment is used to schematically illustrate implementation of this disclosure. The sequence of steps is not limited and may be adjusted appropriately as needed.

An embodiment of this disclosure provides a velocity identification method for interbed multiples. As shown in FIG. 1, the method includes:

step 101: obtaining a velocity spectrum and propagation paths of interbed multiples in a stratum;

step 102: collecting, from the velocity spectrum, velocities of a plurality of energy clusters whose energy exceeds a preset value, and obtaining propagation velocities of a plurality of primaries and propagation duration of the plurality of primaries;

step 103; calculating, based on the propagation duration of the plurality of primaries and propagation velocities of the plurality of primaries, and in combination with the propagation paths of the interbed multiples in the stratum, propagation velocities and propagation duration of interbed multiples corresponding to each primary order by order, to obtain propagation velocities and propagation duration of low-order interbed multiples;

step 104: determining a horizon at which the low-order interbed multiples are generated and an order of the low-order interbed multiples; and

step 105: identifying the interbed multiples based on the propagation velocities and the propagation duration of the low-order interbed multiples, the horizon at which the low-order interbed multiples are generated, and the order of the low-order interbed multiples, and in combination with the velocity spectrum.

In specific implementation, the velocity spectrum and the propagation path of the interbed multiples in the stratum are obtained; the velocities of the plurality of energy clusters whose energy exceeds a preset value are collected from the velocity spectrum, and the propagation velocities of the plurality of primaries and the propagation duration of the plurality of primaries are obtained; the propagation velocities and the propagation duration of the interbed multiples corresponding to each primary are calculated order by order, based on the propagation duration of the plurality of primaries and propagation velocities of the plurality of primaries, and in combination with the propagation paths of the interbed multiples in the stratum, to obtain the propagation velocities and the propagation duration of the low-order interbed multiples; the horizon at which the low-order interbed multiples are generated and the order of the low-order interbed multiples are determined; and the interbed multiples are identified based on the propagation velocities and the propagation duration of the low-order interbed multiples, the horizon at which the low-order interbed multiples are generated, and the order of the low-order interbed multiples, and in combination with the velocity spectrum.

In the embodiment of this disclosure, in combination with the basis of research on the interbed multiples in recent years, a velocity identification method for interbed multiples is proposed to resolve problems that it is difficult to identify and suppress the interbed multiples, and it is time-consuming and labor-intensive to identify the interbed multiples.

In an embodiment, the calculating, based on the propagation duration of the plurality of primaries and the propagation velocities of the plurality of primaries, and in combination with the propagation paths of the interbed multiples in the stratum, propagation velocities and the propagation duration of the interbed multiples corresponding to each primary order by order includes:

calculating a propagation velocity of first-order interbed multiples and a propagation velocity of second-order interbed multiples, based on the propagation velocities of the plurality of primaries, and the first-order interbed multiples and the second-order interbed multiples are corresponding to the primaries; and

calculating propagation duration of the first-order interbed multiples and propagation duration of the second-order interbed multiples, based on the propagation duration of the plurality of primaries, and the first-order interbed multiples and the second-order interbed multiples are corresponding to the primaries.

In an embodiment, the calculating, based on the propagation duration of the plurality of primaries and the propagation velocities of the plurality of primaries, and in combination with the propagation paths of the interbed multiples in the stratum, the propagation velocities and the propagation duration of the interbed multiples corresponding to each primary order by order further includes:

calculating propagation velocities of third-order interbed multiples and a higher order interbed multiples based on the propagation velocities of the plurality of primaries and in combination with the propagation paths of the interbed multiples in the stratum; and

calculating propagation duration of the third-order interbed multiples and a higher order interbed multiples based on the propagation duration of the plurality of primaries and in combination with the propagation paths of the interbed multiples in the stratum.

For example, the propagation velocities of the low-order interbed multiples are calculated. Assuming that a root mean square velocity of a n-th stratum and time t₀ of the n-th stratum are v_{R,n} and t_{0,n} respectively, and a root mean square velocity of a n−1-th stratum and time t₀ of of the n−1-th stratum are v_{R,n-1} and t_{0,n-1} respectively, and propagation velocities between the n−1-th stratum and the n-th stratum can be calculated, so that a propagation velocity v_{M}_{₁}_{R,(n-1,n)}² of the first-order interbed multiples is:

$${v}_{{M}_{1} R , ( n - 1 , n )}^{2} = \frac{2 {t}_{0 , n} {𝓋}_{R , n}^{2} - {t}_{0 , n - 1} {𝓋}_{R , n - 1}^{2}}{2 {t}_{0 , n} - {t}_{0 , n - 1}}$$

and a propagation velocity v_{M}_{₂}_{R,(n-1,n)}² of the second-order interbed multiples is:

$${v}_{{M}_{2} R , ( n - 1 , n )}^{2} = \frac{3 {t}_{0 , n} {𝓋}_{R , n}^{2} - 2 {t}_{0 , n - 1} {𝓋}_{R , n - 1}^{2}}{3 {t}_{0 , n} - 2 {t}_{0 , n - 1}}$$

In the calculation of the propagation duration of low-order interbed multiples, using the propagation velocity and the propagation duration of the primaries, the propagation duration of the low-order interbed multiples related to the primaries are calculated. A formula of the propagation duration of the interbed multiples between the n−1-th stratum and the n-th stratum is

$${t}_{{M}_{m} R} = {t}_{0 , n p} + {\sum }_{j = 1}^{m} ( {t}_{0 , Mj} - {t}_{0 , Mj - 1} ) ,$$

where nₚ≤n means a maximum stratum in which the primaries propagate, m means an order of the interbed multiples, and v_{Mj} and Mj are respectively a velocity of a horizon at which the interbed multiples are generated and time of which the interbed multiples are generated, respectively corresponding to vᵢ and tᵢ. The propagation duration of the first-order interbed multiples is t_{M}_{₁}_{R,(n-1,n)}=2t_{0,n-1}, and the propagation duration of the second-order interbed multiples is t_{M}_{₂}_{R,(n-1,n)}=3t_{0,n}−2t_{0,n-1}.

For the propagation velocities of the third-order and higher-order interbed multiples, a cumulative velocity and cumulative duration are respectively calculated by using the propagation paths of the interbed multiples in the stratum and based on the foregoing velocity of the stratum and the formula for calculating the root mean square velocity, so that the propagation velocity of the third-order interbed multiples and the propagation velocity of the higher-order interbed multiples are finally obtained.

For the propagation duration of the third-order and higher-order interbed multiples, duration needed to propagate once is calculated based on a propagation path of the interbed multiples in a stratum, and duration is accumulated based on the propagation duration of the primaries, to obtain propagation duration of the third-order and higher-order interbed multiples.

In an embodiment, the identifying the interbed multiples based on the propagation velocities and the propagation duration of the low-order interbed multiples, the horizon at which the low-order interbed multiples are generated, and the order of the low-order interbed multiples, and in combination with the velocity spectrum includes:

searching for corresponding interbed multiples velocities in the velocity spectrum based on the propagation velocities and the propagation duration of the low-order interbed multiples, the horizon at which the low-order interbed multiples are generated, and the order of the low-order interbed multiples.

In an embodiment, the identifying the interbed multiples based on the propagation velocities and the propagation duration of the low-order interbed multiples, the horizon at which the low-order interbed multiples are generated, and the order of the low-order interbed multiples, and in combination with the velocity spectrum includes:

projecting the propagation velocities and the propagation duration of the low-order interbed multiples into the velocity spectrum, and searching for a corresponding interbed multiples energy cluster; and

obtaining, based on the corresponding interbed multiples energy cluster, the horizon at which the low-order interbed multiples are generated, and the order of the low-order interbed multiples, a horizon of primaries that generate the interbed multiples and an order of the primaries.

In specific implementation, identification can be performed in the following two ways:

(1) searching for corresponding interbed multiples velocities in the velocity spectrum based on the propagation velocities and propagation duration of the low-order interbed multiples, the horizon at which the low-order interbed multiples are generated, and the order of the low-order interbed multiples; and

(2) projecting the propagation velocities and the propagation duration of the low-order interbed multiples into the velocity spectrum, and searching for a corresponding interbed multiples energy cluster; and

obtaining, based on the corresponding interbed multiples energy cluster, the horizon at which the low-order interbed multiples are generated, and the order of the low-order interbed multiples, a horizon of primaries that generate the interbed multiples and an order of the primaries.

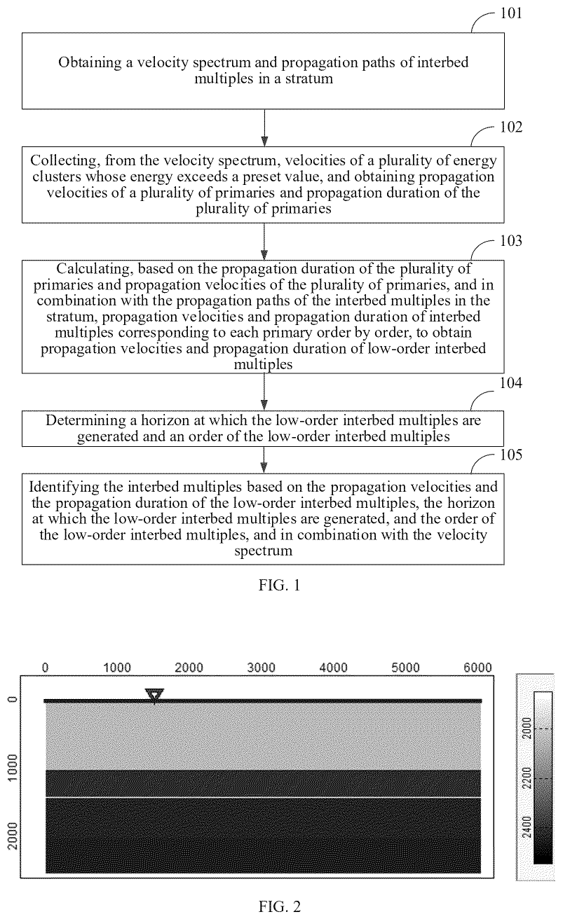

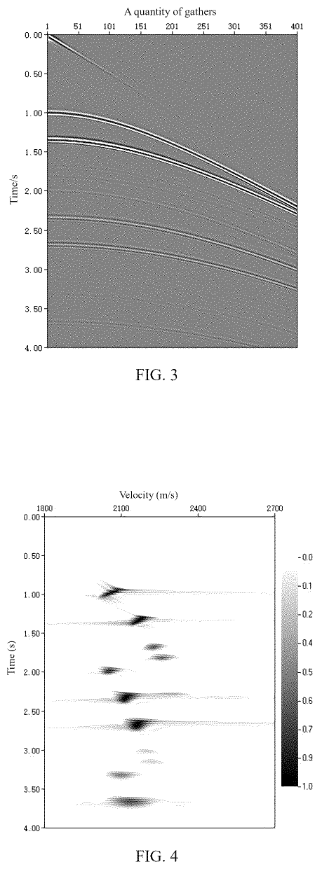

For example, the propagation velocities and propagation duration of the primaries are obtained, and a velocity model shown in FIG. 2 is built, where a horizontal coordinate represents a length in m, and a vertical coordinate represents a depth in m. There are four layers and three reflection interfaces in the velocity model, and velocities are 2,050 m/s, 2,450 m/s, 2,500m/s, and 2,550 m/s respectively. To generate strong interbed multiples, a second reflection interface contains a coal layer with a thickness of 19 m, and a propagation velocity of the coal layer is 1,850m/s. Finite difference forward modeling is performed on the velocity model shown in FIG. 2, gathers shown in FIG. 3 are obtained, a direct wave in the gathers is removed, and velocity analysis is performed on remaining waves, and a velocity spectrum shown in FIG. 4 is obtained. It can be learned that energy clusters with propagation duration of less than 2 s are all interbed multiples energy clusters. Based on analysis of the velocity model, a third energy cluster (at approximately 1.7 s) from top to bottom among four energy clusters with propagation duration of more than 2 s is interbed multiples energy, and propagation velocities and propagation duration of a first energy cluster, a second energy cluster, and a fourth energy cluster are collected.

The propagation velocities of the low-order interbed multiples are calculated by using a collected propagation velocities of a primaries. The propagation duration of the low-order interbed multiples are calculated by using collected propagation duration of the primaries. The interbed multiples are identified by using the velocity spectrum and the propagation velocities and the propagation duration of the low-order interbed multiples.

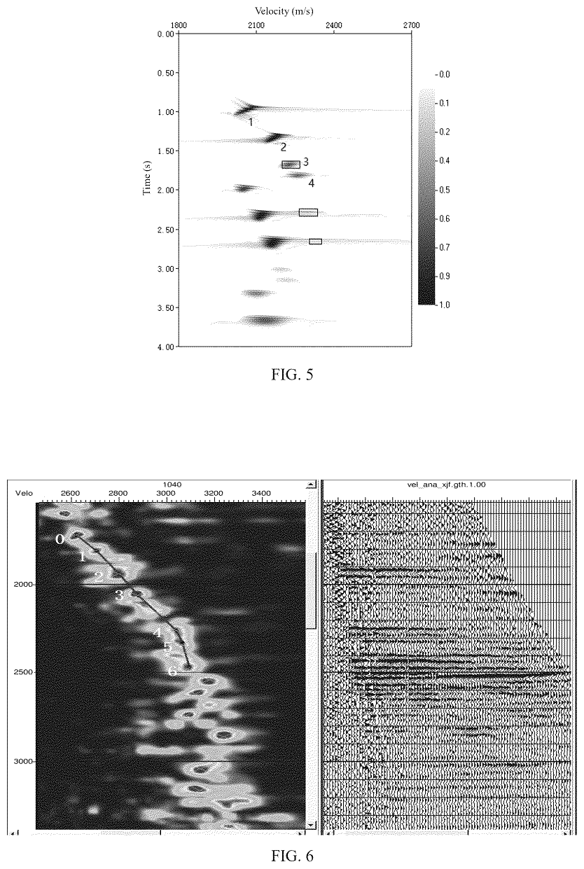

FIG. 5 is a schematic diagram of velocity identification of interbed multiples according to an embodiment of this disclosure. As shown in FIG. 5, propagation velocities and propagation duration are calculated by using the velocity identification method for the interbed multiples according to an embodiment of this disclosure, and a calculation result is displayed in a velocity spectrum, as shown in energy clusters in a frame of FIG. 5. The method can correctly identify the interbed multiples.

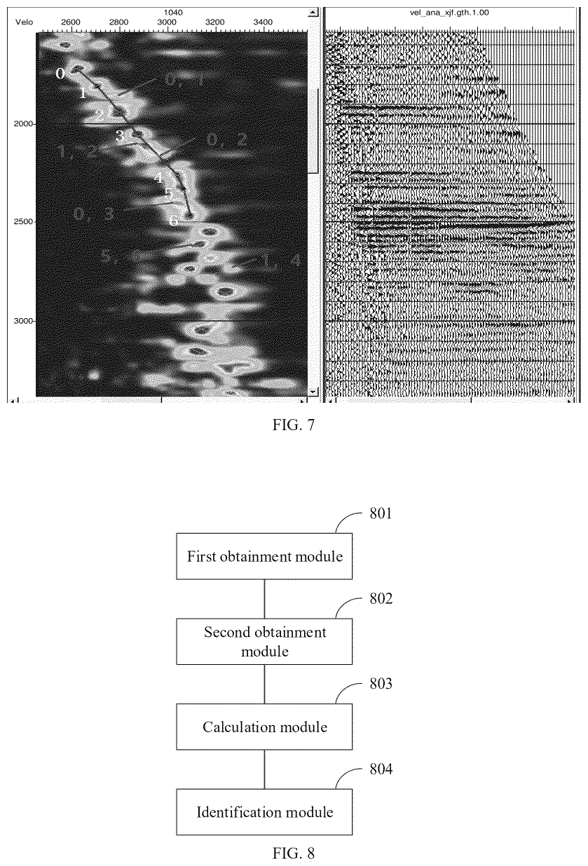

For example, FIG. 6 is a schematic diagram of a actual CMP gathers and a velocity spectrum thereof according to an embodiment of this disclosure. In FIG. 6, a left side of FIG. 6 shows the velocity spectrum, and a right side of FIG. 6 shows the CMP gathers. It can be learned that propagation velocities and propagation duration of seven energy clusters of primaries numbered 0 to 6 are collected, the propagation velocities and propagation duration of the seven primaries are used, and the identification method provided in this disclosure is used to calculate a suppression velocity and duration of the interbed multiples and identify the interbed multiples. FIG. 7 shows energy clusters of the identified interbed multiples. In FIG. 7, “0, 1” respectively represent interbed multiples generated by primaries numbered 0 and 1, and “0, 2” respectively represent interbed multiples generated by primaries numbered 0 and 2. Errors between the calculated velocities of the interbed multiples and velocities of the interbed multiples collected from the velocity spectrum are shown in Table 1. It can be learned that as an error is smaller, it indicates that the method provided in this disclosure is correct and reliable.

TABLE 1
Velocity errors of interbed multiples

| | Horizon at | | | | |
|---|---|---|---|---|---|
| | which interbed | Calculated | Real | Absolute | Relative |
| | multiples are | velocity | velocity | error | error |
| No. | generated | (m/s) | (m/s) | (m/s) | (%) |
| 1 | 0, 1 | 2787 | 2780 | 7 | 0.25 |
| 2 | 1, 2 | 2875 | 2880 | 5 | 0.17 |
| 3 | 0, 2 | 2934 | 2950 | 16 | 0.54 |
| 4 | 0, 3 | 3053 | 3040 | 13 | 0.43 |
| 5 | 5, 6 | 3097 | 3110 | 13 | 0.42 |
| 6 | 1, 4 | 3239 | 3260 | 21 | 0.64 |

An embodiment of this disclosure further provides a velocity identification apparatus for interbed multiples, as described in the following embodiment. Because a principle in which a problem is resolved by using the apparatus is similar to the velocity identification method for interbed multiples, for implementation of the apparatus, reference may be made to the implementation of the method, which is not repeated herein again.

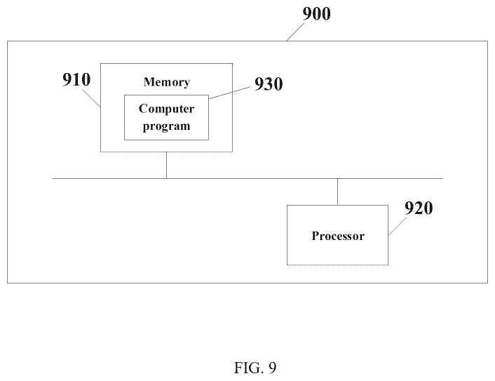

FIG. 8 is a schematic diagram of the velocity identification apparatus for interbed multiples according to an embodiment of this disclosure. As shown in FIG. 8, the apparatus includes:

a first obtainment module 801, configured to obtain a velocity spectrum and propagation paths of interbed multiples in a stratum;

a second obtainment module 802, configured to collect, from the velocity spectrum, velocities of a plurality of energy clusters whose energy exceeds a preset value, and obtain propagation velocities of a plurality of primaries and propagation duration of a plurality of primaries;

a calculation module 803, configured to calculate, based on the propagation duration of the plurality of primaries and propagation velocities of the plurality of primaries, and in combination with the propagation paths of the interbed multiples in the stratum, propagation velocities and propagation duration of interbed multiples corresponding to each primary order by order, to obtain propagation velocities and propagation duration of low-order interbed multiples; and determine a horizon at which the low-order interbed multiples are generated and an order of the low-order interbed multiples; and

an identification module 804, configured to identify the interbed multiples based on the propagation velocities and the propagation duration of the low-order interbed multiples, the horizon at which the low-order interbed multiples are generated, and the order of the low-order interbed multiples, and in combination with the velocity spectrum.

In an embodiment, the calculation module 803 is specifically configured to:

calculate a propagation velocity of a first-order interbed multiples corresponding to the primaries and a propagation velocity of a second-order interbed multiples corresponding to the primaries, based on the propagation velocities of the plurality of primaries; and

calculate propagation duration of the first-order interbed multiples corresponding to the primaries and propagation duration of the second-order interbed multiples corresponding to the primaries, based on the propagation duration of the plurality of primaries.

In an embodiment, the calculation module 803 is further configured to:

calculate propagation velocities of a third-order interbed multiple and a higher order interbed multiples based on the propagation velocities of the plurality of primaries and in combination with the propagation paths of the interbed multiples in the stratum; and

calculate propagation duration of the third-order interbed multiple and a higher order interbed multiples based on the propagation duration of the plurality of primaries and in combination with the propagation paths of the interbed multiples in the stratum.

In an embodiment, the identification module 804 is specifically configured to:

search for corresponding interbed multiples velocities in the velocity spectrum based on the propagation velocities and propagation duration of the low-order interbed multiples, the horizon at which the low-order interbed multiples are generated, and the order of the low-order interbed multiples.

In an embodiment, the identification module 804 is specifically configured to:

project the propagation velocities and the propagation duration of the low-order interbed multiples into the velocity spectrum, and search for a corresponding interbed multiples energy cluster; and

obtain, based on the interbed multiples energy cluster, the horizon at which the low-order interbed multiples are generated, and the order of the low-order interbed multiples, a horizon of primaries that generate the interbed multiples and an order of the primaries.

Based on the foregoing inventive concept, as shown in FIG. 9, this disclosure further provides a computer device 900, including a memory 910, a processor 920, and a computer program 930 stored on the memory 910 and executable on the processor 920. When executing the computer program 930, the processor 920 implements the velocity identification method for an interbed multiples.

An embodiment of this disclosure further provides a computer-readable storage medium. The computer-readable storage medium stores a computer program. When executed by a processor, the computer program implements the velocity identification method for an interbed multiples.

An embodiment of this disclosure further provides a computer program product. The computer program product includes a computer program. When executed by a processor, the computer program implements the velocity identification method for an interbed multiples.

To sum up, in the embodiments of this disclosure, the velocity spectrum and the propagation path of the interbed multiples in the stratum are obtained; the velocities of the plurality of energy clusters whose energy exceeds a preset value are collected from the velocity spectrum, and the propagation velocities of the plurality of primaries and the propagation duration of the plurality of primaries are obtained; the propagation velocities and the propagation duration of the interbed multiples corresponding to each primary are calculated order by order, based on the propagation duration of the plurality of primaries and propagation velocities of the plurality of primaries, and in combination with the propagation paths of the interbed multiples in the stratum, to obtain the propagation velocities and the propagation duration of the low-order interbed multiples; the horizon at which the low-order interbed multiples are generated and the order of the low-order interbed multiples are determined; and the interbed multiples are identified based on the propagation velocities and the propagation duration of the low-order interbed multiples, the horizon at which the low-order interbed multiples are generated, and the order of the low-order interbed multiples, and in combination with the velocity spectrum. In this way, based on the propagation velocities of the primaries and propagation duration of the primaries, the propagation velocities and propagation duration of the low-order interbed multiples are calculated, and then in combination with the velocity spectrum the interbed multiples are identified, so that the velocity spectrum of the interbed multiples can be identified, the horizon at which the interbed multiples are generated, and the order of the interbed multiples can be obtained, thereby providing effective information for suppression of the interbed multiples.

A person skilled in the art should understand that embodiments of this disclosure may be provided as a method, a system, or a computer program product. Therefore, a form of a hardware-only embodiment, a software-only embodiment, or an embodiment with a combination of software and hardware may be used in this disclosure. In addition, a form of a computer program product that is implemented on one or more computer-usable storage media (including but not limited to a disk memory, a CD-ROM, an optical memory, and the like) that include a computer-usable program code may be used in this disclosure.

This disclosure is described with reference to the flowcharts and/or block diagrams of the method, the apparatus (system), and the computer program product in the embodiments of this disclosure. It should be understood that each process and/or block in the flowchart and/or block diagram as well as a combination of processes and/or blocks in the flowchart and/or block diagram may be implemented by computer program instructions. These computer program instructions can be provided to a general-purpose computer, a special-purpose computer, an embedded processor, or a processor of another programmable data processing equipment to generate a machine, so that a device configured to implement functions specified in one or more procedures of a flowchart and/or one or more blocks of a block diagram is generated by using the instructions executed by the computer or the processor of the another programmable data processing device.

These computer program instructions may also be stored in a computer readable memory that can instruct the computer or any other programmable data processing device to work in a specific manner, so that the instructions stored in the computer readable memory generate an artifact that includes an instruction device. The instruction device implements a function specified in one or more procedures of the flowchart and/or in one or more blocks of the block diagram.

These computer program instructions may also be loaded onto a computer or another programmable data processing device, so that a series of operation steps are performed on the computer or another programmable equipment to produce computer-implemented processing, thereby providing instructions executed on the computer or another programmable equipment to implement steps for the function specified in one or more processes of the flowchart and/or one or more blocks of the block diagram.

In the above specific embodiments, the objectives, technical solutions, and beneficial effects of this disclosure are further described in detail. It should be understood that the above descriptions are merely specific embodiments of this disclosure, but are not intended to limit the protection scope of this disclosure. Any modification, equivalent replacement, improvement, or the like made without departing from the spirit and principle of this disclosure shall fall within the protection scope of this disclosure

1. A velocity identification method for an interbed multiples, comprising:
obtaining a velocity spectrum and propagation paths of interbed multiples in a stratum;
collecting, from the velocity spectrum, velocities of a plurality of energy clusters whose energy exceeds a preset value, and obtaining propagation velocities of a plurality of primaries and propagation duration of the plurality of primaries;
calculating, based on the propagation duration of the plurality of primaries and propagation velocities of the plurality of primaries, and in combination with the propagation paths of the interbed multiples in the stratum, propagation velocities and propagation duration of interbed multiples corresponding to each primary order by order, to obtain propagation velocities and propagation duration of low-order interbed multiples;
determining a horizon at which the low-order interbed multiples are generated and an order of the low-order interbed multiples; and
identifying the interbed multiples based on the propagation velocities and the propagation duration of the low-order interbed multiples, the horizon at which the low-order interbed multiples are generated, and the order of the low-order interbed multiples, and in combination with the velocity spectrum.

2. The method according to claim 1, wherein the calculating, based on the propagation duration of the plurality of primaries and the propagation velocities of the plurality of primaries, and in combination with the propagation paths of the interbed multiples in the stratum, the propagation velocities and the propagation duration of the interbed multiples corresponding to each primary order by order comprises:
calculating a propagation velocity of first-order interbed multiples corresponding to the primaries and a propagation velocity of second-order interbed multiples corresponding to the primaries, based on the propagation velocities of the plurality of primaries; and
calculating propagation duration of the first-order interbed multiples corresponding to the primaries and propagation duration of the second-order interbed multiples corresponding to the primaries, based on the propagation duration of the plurality of primaries.

3. The method according to claim 2, wherein the calculating, based on the propagation duration of the plurality of primaries and the propagation velocities of the plurality of primaries, and in combination with the propagation paths of the interbed multiples in the stratum, the propagation velocities and the propagation duration of the interbed multiples corresponding to each primary order by order further comprises:
calculating propagation velocities of a third-order interbed multiples and a higher order interbed multiples based on the propagation velocities of the plurality of primaries and in combination with the propagation paths of the interbed multiples in the stratum; and
calculating propagation duration of the third-order interbed multiples and a higher order interbed multiples based on the propagation duration of the plurality of primaries and in combination with the propagation paths of the interbed multiples in the stratum.

4. The method according to claim 1, wherein the identifying the interbed multiples based on the propagation velocities and the propagation duration of the low-order interbed multiples, the horizon at which the low-order interbed multiples are generated, and the order of the low-order interbed multiples, and in combination with the velocity spectrum comprises:
searching for corresponding interbed multiples velocities in the velocity spectrum based on the propagation velocities and the propagation duration of the low-order interbed multiples, the horizon at which the low-order interbed multiples are generated, and the order of the low-order interbed multiples.

5. The method according to claim 1, wherein the identifying the interbed multiples based on the propagation velocities and the propagation duration of the low-order interbed multiples, the horizon at which the low-order interbed multiples are generated, and the order of the low-order interbed multiples, and in combination with the velocity spectrum comprises:
projecting the propagation velocities and the propagation duration of the low-order interbed multiples into the velocity spectrum, and searching for a corresponding interbed multiples energy cluster; and
obtaining, based on the interbed multiples energy cluster, the horizon at which the low-order interbed multiples are generated, and the order of the low-order interbed multiples, a horizon of primaries that generate the interbed multiples.

6. A velocity identification apparatus for an interbed multiples, comprising:
a first obtainment module, configured to obtain a velocity spectrum and propagation paths of interbed multiples in a stratum;
a second obtainment module, configured to collect, from the velocity spectrum, velocities of a plurality of energy clusters whose energy exceeds a preset value, and obtain propagation velocities of a plurality of primaries and propagation duration of the plurality of primaries;
a calculation module, configured to calculate, based on the propagation duration of the plurality of primaries and propagation velocities of the plurality of primaries, and in combination with the propagation paths of the interbed multiples in the stratum, propagation velocities and propagation duration of interbed multiples corresponding to each primary order by order, to obtain propagation velocities and propagation duration of low-order interbed multiples; and determine a horizon at which a low-order interbed multiples are generated and an order of the low-order interbed multiples; and
an identification module, configured to identify the interbed multiples based on the propagation velocities and the propagation duration of the low-order interbed multiples, the horizon at which the low-order interbed multiples are generated, and the order of the low-order interbed multiples, and in combination with the velocity spectrum.

7. The apparatus according to claim 6, wherein the calculation module is configured to:
calculate a propagation velocity of first-order interbed multiples corresponding to the primaries and a propagation velocity of second-order interbed multiples corresponding to the primaries, based on the propagation velocities of the plurality of primaries; and
calculate propagation duration of the first-order interbed multiples corresponding to the primaries and propagation duration of the second-order interbed multiples corresponding to the primaries, based on the propagation duration of the plurality of primaries.

8. The apparatus according to claim 7, wherein the calculation module is further configured to:
calculate propagation velocities of a third-order interbed multiples and a higher order interbed multiples based on the propagation velocities of the plurality of primaries and in combination with the propagation paths of the interbed multiples in the stratum; and
calculate propagation duration of the third-order interbed multiples and a higher order interbed multiples based on the propagation duration of the plurality of primaries and in combination with the propagation paths of the interbed multiples in the stratum.

9. The apparatus according to claim 6, wherein the identification module is configured to:
search for corresponding interbed multiples velocities in the velocity spectrum based on the propagation velocities and the propagation duration of the low-order interbed multiples, the horizon at which the low-order interbed multiples are generated, and the order of the low-order interbed multiples.

10. The apparatus according to claim 6, wherein the identification module is configured to:
project the propagation velocities and the propagation duration of the low-order interbed multiples into the velocity spectrum, and search for a corresponding interbed multiples energy cluster; and
obtain, based on the interbed multiples energy cluster, the horizon at which the low-order interbed multiples are generated, and the order of the low-order interbed multiples, a horizon of primaries that generate the interbed multiples.

11. A computer device, comprising a memory, a processor, and a computer program stored in the memory and executable on the processor, wherein when executing the computer program, the processor implements a velocity identification method for an interbed multiples,
wherein the velocity identification method for an interbed multiples comprises:
obtaining a velocity spectrum and propagation paths of interbed multiples in a stratum;
collecting, from the velocity spectrum, velocities of a plurality of energy clusters whose energy exceeds a preset value, and obtaining propagation velocities of a plurality of primaries and propagation duration of the plurality of primaries;
calculating, based on the propagation duration of the plurality of primaries and propagation velocities of the plurality of primaries, and in combination with the propagation paths of the interbed multiples in the stratum, propagation velocities and propagation duration of interbed multiples corresponding to each primary order by order, to obtain propagation velocities and propagation duration of low-order interbed multiples;
determining a horizon at which the low-order interbed multiples are generated and an order of the low-order interbed multiples; and
identifying the interbed multiples based on the propagation velocities and the propagation duration of the low-order interbed multiples, the horizon at which the low-order interbed multiples are generated, and the order of the low-order interbed multiples, and in combination with the velocity spectrum.

12. (canceled)

13. (canceled)

14. The computer device according to claim 11, wherein the calculating, based on the propagation duration of the plurality of primaries and the propagation velocities of the plurality of primaries, and in combination with the propagation paths of the interbed multiples in the stratum, the propagation velocities and the propagation duration of the interbed multiples corresponding to each primary order by order comprises:
calculating a propagation velocity of first-order interbed multiples corresponding to the primaries and a propagation velocity of second-order interbed multiples corresponding to the primaries, based on the propagation velocities of the plurality of primaries; and
calculating propagation duration of the first-order interbed multiples corresponding to the primaries and propagation duration of the second-order interbed multiples corresponding to the primaries, based on the propagation duration of the plurality of primaries.

15. The computer device according to claim 14, wherein the calculating, based on the propagation duration of the plurality of primaries and the propagation velocities of the plurality of primaries, and in combination with the propagation paths of the interbed multiples in the stratum, the propagation velocities and the propagation duration of the interbed multiples corresponding to each primary order by order further comprises:
calculating propagation velocities of a third-order interbed multiples and a higher order interbed multiples based on the propagation velocities of the plurality of primaries and in combination with the propagation paths of the interbed multiples in the stratum; and
calculating propagation duration of the third-order interbed multiples and a higher order interbed multiples based on the propagation duration of the plurality of primaries and in combination with the propagation paths of the interbed multiples in the stratum.

16. The computer device according to claim 11, wherein the identifying the interbed multiples based on the propagation velocities and the propagation duration of the low-order interbed multiples, the horizon at which the low-order interbed multiples are generated, and the order of the low-order interbed multiples, and in combination with the velocity spectrum comprises:
searching for corresponding interbed multiples velocities in the velocity spectrum based on the propagation velocities and the propagation duration of the low-order interbed multiples, the horizon at which the low-order interbed multiples are generated, and the order of the low-order interbed multiples.

17. The computer device according to claim 11, wherein the identifying the interbed multiples based on the propagation velocities and the propagation duration of the low-order interbed multiples, the horizon at which the low-order interbed multiples are generated, and the order of the low-order interbed multiples, and in combination with the velocity spectrum comprises:
projecting the propagation velocities and the propagation duration of the low-order interbed multiples into the velocity spectrum, and searching for a corresponding interbed multiples energy cluster; and
obtaining, based on the interbed multiples energy cluster, the horizon at which the low-order interbed multiples are generated, and the order of the low-order interbed multiples, a horizon of primaries that generate the interbed multiples.
